(19) United States
(12) Patent Application Publication
(10) Pub. No.: US 2012/0263430 A1
(43) Pub. Date: Oct. 18, 2012

(54) BOOKMARKING MOMENTS IN A RECORDED VIDEO USING A RECORDED HUMAN ACTION

(76) Inventor: Noah Spitzer-Williams, Seattle, WA (US)

(21) Appl. No.: 13/436,763

(22) Filed: Mar. 30, 2012

Related U.S. Application Data
(60) Provisional application No. 61/516,334, filed on Mar. 31, 2011.

(51) Int. Cl. H04N 9/80; H04N 5/77

(52) U.S. Cl. 386/224; 386/E05.069

(57) ABSTRACT

Video highlights are captured from a video stream during a video recording session of activity in which manual inputs to the camera would be difficult, impossible, or inconvenient for the user. The user provides a software-recognizable signal to the camera, such as by covering the camera lens for a brief time, shouting a high pitched tone or a recognizable word, or making a specific hand gesture in front of the lens that is software-recognizable. Using a programmed computer, the user searches for and locates any bookmarks or flags in the video stream of the activity, and copies to a highlight file a video highlight clip for each event of interest. Such a highlight clip can be, for example, thirty seconds of video up until and including the time of the bookmark. The user can then review only the highlight video clips, rather than the entire video sequence.

This application claims benefit of provisional application Ser. No. 61/516,334, filed Mar. 31, 2011.

### BACKGROUND OF THE INVENTION

This invention concerns video photography, and particularly a system for placing a “bookmark” in raw video as it is being produced or recorded, to establish locations of interest in the video.

Wearable cameras, sometimes referred to as helmet cameras, have become more and more popular in recent years. These hands-free devices allow sports enthusiasts to record themselves doing things like snowboarding, surfing, and mountain biking. Although the video quality, durability, storage capacity, and battery life of these cameras has improved dramatically over the years, one problem still remains: footage overload. Users often end up with hours of footage and most of it is pretty boring. Therefore, when a user comes home and creates a highlight reel, this requires manually searching through many hours of footage just to find the good moments.

Today, some users attempt to minimize the amount of boring footage by starting and stopping recording over and over again. This workaround fails because the user may miss unexpected moments and it is extremely tedious, especially with gloves on.

Also, some video cameras have been provided with manual buttons (on or off the camera) that will establish a bookmark on the video when the user presses the button. It can be cumbersome, difficult and often impossible to press the button during an activity.

This invention represents a way for users to bookmark the good moments as they happen so it is not necessary to search through hours of footage later on. This makes creating highlight reels significantly faster and easier because the software can automatically find the bookmarks.

Although footage overload is easily caused when using wearable cameras, there are other scenarios that cause this as well. For example, a parent often records his child playing sports using a standard point and shoot camera. He might record the whole game but ultimately is only interested in the times when his son touched the ball. It would be ideal if he could bookmark these moments while he watched the game, so he could find them quicker later on. Further, a user might be recording himself in an activity (dance or song rehearsal, etc.) and may want to flag and review certain highlights. Therefore, this invention is not strictly limited to the use of wearable cameras.

### SUMMARY OF THE INVENTION

This invention primarily consists of two parts:

1. A system or procedure for a user to bookmark good moments as they are being recorded to a video.

2. Software that scans through the user's video and locates the bookmarks.

This invention's functionality provides value to both end-users and camera manufacturers.

1. For end users:
a. This invention makes it significantly easier and faster to create highlight reels. The highlights are automatically found so users can spend more time enjoying the good moments, rather than searching for them.
b. With users not having to worry about manually hunting through hours of footage for the good moments, cameras can be left recording for far longer. This means the chance of missing a great unexpected moment is significantly reduced.
c. Users can bookmark moments without pressing a button on the device. This avoids situations such as trying to press a button while wearing bulky gloves, or hunting for the bookmark button when the camera is not in view (e.g. attached to a helmet).

2. For camera manufacturers:
a. This additional functionality can be provided without making any hardware modifications to the cameras. This is inexpensive for manufacturers and also allows them to provide this functionality to cameras that are already on the market.
b. If used exclusively, this can be a differentiating feature against competitors.
c. In today's world, a user buys a video camera for the purpose of capturing experiences. However, once the user ends up with hours of footage to comb through, the camera may not seem worth its price. By camera manufacturers providing this functionality, users will become more loyal to the camera manufacturer's brand.

The first part of this invention involves how the user bookmarks the moments (i.e. performs the bookmark action). The primary use case is that the user sets the camera to record as soon as the session or activity begins and ceases recording only when the session is over. This way the possibility of ever missing a highlight is eliminated. When the user experiences a moment of interest, the user performs the bookmark action immediately after the moment happens. For example, if snowboarding down a mountain and landing a big jump, the user should perform the bookmark action just after the landing. The system could be set to recognize bookmarks made just before (rather than after) an anticipated moment of interest. The software which later copies highlight clips could offer a choice to the user, to select prior bookmarking or subsequent bookmarking, based on how the bookmarks were set by the user during video recording.

The scope of bookmark actions could include anything that would be recorded by the camera (e.g. a visual cue or an audible cue). In two main implementations, two bookmark actions are specifically discussed: covering the lens, and shouting a high-pitched (or loud, sharp) noise. A third implementation is to cover the lens and loudly speak an identifier phrase such as “snowboarding jump”, to give the bookmark a name for later reference (not as a machine-recognizable command); other visual signals can also be used as bookmarks.

### Definitions

1. A highlight represents a moment that the user would like to easily locate later on. It can be the video snippet that is ultimately shared with friends by the end user.

2. A bookmark represents a time in the video or audio file that has been marked by the user because it represents a highlight.

3. A bookmark action is what the user must perform to bookmark the highlight. In the initial implementations, the bookmark action is either performed by the user covering the camera lens with a hand or by shouting a high pitched or other easily recognized noise (e.g. “woohoo!”), depending on what is appropriate to the situation. Other machine-recognizable gestures could be used, and the recording of a signal in the video is intended to encompass visual or audible signals.

4. A session is the period of time in which the user is doing some action or sport to be recorded and reviewed later on. In the case of snowboarding, this is from the time the user arrives at the mountain to the time the activity ends, or a shorter segment if desired.

5. A recording sequence is the video recording stream made during a session.

6. A highlight reel is a compilation of highlights, sometimes with a title screen and post-production effects. It can also be the video that is ultimately shared with friends by the end user.

A typical scenario with a wearable camera can be as follows:

1. User goes snowboarding for the day and records several hours of footage on a wearable camera.

2. While snowboarding, user performs the bookmark action after recording any moment that might be of interest.

3. User comes home and plugs the camera into a computer.

4. User launches software and selects videos on the camera to scan.

5. User begins scan and waits for it to finish.

6. When scan is finished, the user is shown all the highlight videos that were found.

7. The user can then take these highlight videos and share them with friends or import them into a separate piece of software to make further edits or add effects.

### High-Level Implementation

In a preferred implementation, the bookmark action is performed by the user immediately after recording a moment of interest. The bookmark action is recorded into the video so the software can locate it afterward. The software that scans and locates the bookmarks is run on a computer, after the session (although the scan could be done in a computer onboard the camera, or discussed below). For every bookmark the software locates, a 30 second video clip (i.e. the highlight) is spliced out into a new file, leaving the original file unharmed. The video clip is meant to end at the time of the bookmark action. Thus it captures the previous 30 seconds, for example. This duration is configurable by the user. After the scan is done, the user can import the 30 second clips into video editing software and make further edits.

Although the software is run on a PC in one implementation, the scanning for bookmarks can be done on the camera itself, in real time, by an onboard processor. This will avoid any sort of post-processing to locate the bookmarks. As soon as the user imports videos from the camera, the bookmarks will have already been located, and the user's computer can copy the highlight video clips to a highlight file. The camera can be even equipped to produce the bookmarked clips, i.e. the highlights, as separate files, such as on an SD card when that is the camera's data storage medium. The camera can connect (e.g. wirelessly) to a smartphone or tablet computer, in one embodiment of the invention to list the bookmark/highlights on the smartphone or tablet computer for later copying of highlights on another computer. In another form of the invention, the smartphone or tablet computer can import the highlights to the smartphone, without requiring a second computer.

### DESCRIPTION OF THE DRAWINGS

FIG. 1 is a flow chart outlining operation of the system and method of the invention.

FIG. 2 is a schematic diagram of an example timeline showing bookmarks and highlight video clips.

FIG. 3 is another schematic drawing to illustrate scanning engine process.

FIG. 4 is an example graph showing audio amplitude over time during a video recording, for detection of a bookmark in the recording.

FIG. 5 is a view showing a snowboarding activity with the user/snowboarder making a visual bookmark.

### DESCRIPTION OF PREFERRED EMBODIMENTS

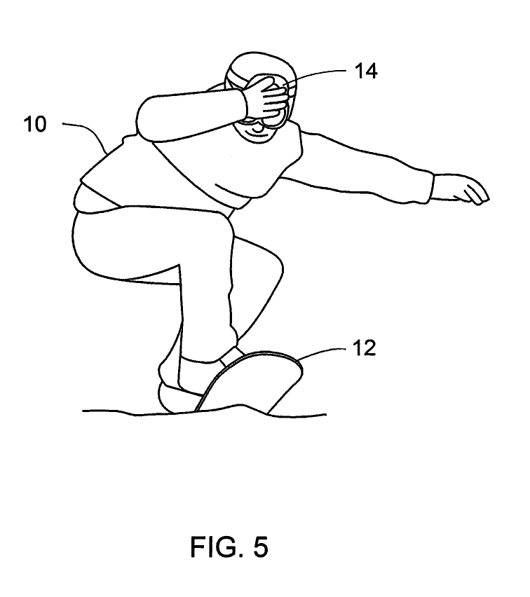

FIG. 5 shows a snowboarder 10 on a snowboard 12, demonstrating an aspect of the invention. The snowboarder wears a video camera 14 on a helmet or on his head to record a sequence of activity. He makes a bookmark or flag in the video recording, in this example by placing his gloved hand in front of the camera lens to produce several dark frames in the video.

### Bookmark Actions

The user has a choice of which bookmark action to use, depending on the situation. The bookmark actions preferably can be used interchangeably.

1. Lens Cover (FIG. 5)

In our software, the bookmark action can be performed by the user's covering the lens of the camera for a moment (for example, ⅛ of a second involving multiple frames). The user will be instructed to do this with a hand (with or without a glove) but conceivably could use other means to cover the lens. This causes the camera to record several dark frames in a row. Later on, the software will scan through each frame of the video, looking for these dark frames.

2. High-Pitched Voice or Other Distinct Sound

Another bookmark action is performed by the user's shouting a high-pitched noise such as “woohoo!” or “yeeeeehaw!” This bookmark action is more appropriate when the camera is not within reach. Later on, the software will scan through the audio frequencies and look for these spikes in pitch. The software could be made to recognize another type of distinct word or sound, not necessarily high pitched.

3. Lens Cover Coupled with Verbal Identifier

The lens covering bookmark action noted above can be accompanied by a verbal identifier, not to be machine-recognized but simply to be present in the video highlight for later reference of the user. For example, the user might cover the lens and speak loudly “ski jump number four!”.

4. Colors as Bookmark Signals

The bookmark action could take other forms, including variations that send different commands to the software when it scans the video. As an example, one or more colors could be the signal of a bookmark, without requiring that the user actually cover the lens. In snowboarding or skiing, for example, the user could have a glove bearing a certain color. The programming which ultimately scans the video for bookmarks can be made to respond to a solid block of that color. Further, the programming could distinguish between two different blocks of colors, such as red and blue, and the user can carry the second color on the opposite glove. The two colors could thus be used for differentiating bookmarks, such as one commanding a thirty second highlight clip and one commanding a shorter or longer highlight clip.

5. Other Gestures or Indicators

Other gestures can be used to initiate bookmarks, such as hand signals recognizable by the software. Multiple, different signals can be used for different bookmark commands. As an example, the user's raising two fingers directly in front of the camera can be one bookmark signal, while raising five fingers in front of the camera can indicate a different bookmark signal and command. The higher number of fingers could indicate a longer duration for the highlight clip, or it could indicate a very important moment in the user's activity that should be given some form of priority for later viewing.

Visual software-recognizable signals recorded in the video sequence as bookmarks can include hand gestures, sudden moves with the camera (such as, when mounted on a user's helmet, pointing the camera at the sky or sudden back-and-forth or up-and-down movements or shaking the camera), rotation of the camera, or any other software-recognizable recorded signal not requiring the pushing of a camera button or hand contact with the camera (such contact referred to “manual input” herein).

### Technical Details of Scanning Engine

The role of the scanning engine is to scan through each frame of the recorded video and look for the bookmark action in series of frames. The scanning engine is built as a reusable component that can be integrated into another software application with a user interface. It contains a number of parameters that can be adjusted based on user preferences and developer preferences. The engine was written in C# using version 4 of the Microsoft .NET Framework. It relies on a number of components and libraries to do its job.

### Dependent Components

Although the initial implementation uses the following components, this invention encompasses any implementation in which the video file is read frame by frame, including those on non-Windows operating systems. For example, an Apple Macintosh does not have Microsoft DirectShow, and therefore another component would be used to read video files frame by frame.

1. Microsoft DirectShow application programming interface (API) is a media-streaming architecture for Microsoft Windows. It allows the scanning engine to crack open the user's video and scan through each frame. DirectShow will automatically search the system for a filter(s) that can read the file. Therefore, a different filter may be used on each system. The scanning engine can alternatively be written in C++, leveraging the open source software component FFmpeg. In that case paragraphs 2 through 5 below will not apply.

2. DirectShowNet (http://directshownet.sourceforge.net) allows .NET applications to access Microsoft DirectShow functionality. This component is provided under the Lesser GPL license (http://www.gnu.org/licenses/lgpl.html).

3. DxScan sample from DirectShowNet is what was used as the starting point for the scanning engine. It demonstrates how to use DirectShowNet to scan through a file for dark frames. The sample is in the public domain.

4. MP4Splitter.ax (http://sourceforge.net/projects/guliverkli/) is a DirectShow filter that is used by Microsoft DirectShow to read the user's videos. It is responsible for splitting certain video types into separate audio and video streams. The binary is provided under the GPL license (http://www.gnu.org/licenses/gpl.html).

5. MPCVideoDec.ax is a DirectShow filter that is used by Microsoft DirectShow to read the user's videos. The binary is provided under the GPL license (http://www.gnu.org/licenses/gpl.html).

6. FFmpeg (http://www.ffmpeg.org) is a tool that is used to splice out a highlight video for each bookmark found. The binary used is provided under the lesser GPL license(http://www.gnu.org/licenses/lgpl.html).

### Engine Parameters

1. For the Lens Cover bookmark action, darkness threshold parameters are used to determine how strict the scanning engine should be when looking for the bookmark action of covering the lens. The initial implementation comes with a default set of parameters that were generated by testing several hours of video footage. The user can also adjust these parameters in case bookmark actions are being missed or there are too many false positives. There are preferably four parameters:
a. PixelDarkness is a value that represents the darkness of an individual pixel in a frame of video for the pixel to be considered “dark”.
b. FrameDarkness is a value that represents the number of dark pixels needed in a single frame for the entire frame to be considered “dark”.
c. ConsecutiveDarkFrames is a value that represents how many dark frames in a row are needed to represent an actual highlight.
d. SkipFrames is a value representing how many frames the engine should skip while scanning, allowing the scan to run significantly faster.

2. For the High-pitched Voice bookmark action, pitch threshold parameters are used to determine how strict the scanning engine should be when looking for the bookmark action of shouting a high pitched noise. The user can also adjust these parameters in case bookmark actions are being missed or there are too many false positives. As noted above, a recognizable word command or other specific sound could be used, with appropriate known software, and other signals could be used as well.

3. Highlight Duration is a value that represents how many seconds of video should be spliced out before the bookmark action. In the initial implementation, two seconds are added to this value so the video clip ends immediately after the end of the bookmark action. This way the user can see why the scanning engine believed it located a bookmark action at that time.

4. Ignore Early Highlights determines whether the software should include highlights found in the first ten seconds of a video. This setting is available because false positives may be generated during the first few seconds of recording when the user is attaching the camera to a helmet.

### Software Operations Workflow

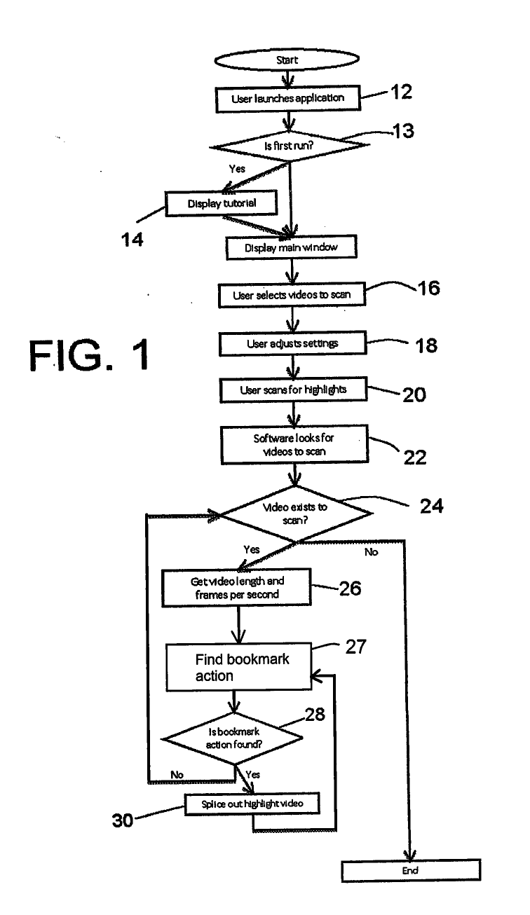

This illustrates what the software does from start to finish, as schematically illustrated in the flow chart of FIG. 1.

1. ApplicationLaunch

When the application is launched by the user (block 12), a short tutorial, as indicated at 14, is displayed to explain to the user how to bookmark moments as they are recorded. This tutorial can be hidden on subsequent launches of the application (decision block 13).

2. SelectVideoToScan

The user can choose to scan a single video or to scan an entire folder of videos, indicated at 16 in the flow chart.

3. AdjustSettings—Block 18

The user has three settings that can be adjusted.
i. Highlight duration—how long the spliced out highlight videos should be.
ii. Detection threshold—how strict or loose the engine should be when searching for the dark frames.
iii. Ignore early highlights—whether the software should include highlights found in the first ten seconds of a video. As explained above, this setting is available because false positives may be generated during the first few seconds of recording when the user is attaching the camera to the helmet.

4. ScanForHighlights—Block 20

Once the user has adjusted the settings and chosen the videos to scan, the user activates a scan for highlights, as indicated in the block 20.

5. LookForVideos—Block 22

Based on what the user has in the UI, the software searches the user's hard drive for the videos desired to be scanned, as indicated in the block 22.

6. CountVideos(S)

The software makes sure there are actually videos to scan (decision block 24). For example, the user may have chosen a folder that doesn't have any videos in it.

7. VerifyWriteAccessToOuputDirectory

Since the software will be saving out any highlight videos it finds, it makes sure the software has write-access to the output folder (not shown in flow chart).

8. For each video that is scanned
i. GetVideoLength—Block 26
   The length of the video is retrieved so the software can accurately display current scan progress to the user.
ii. GetFramesPerSecond
   The frame rate of the video is retrieved so the software can accurately display current scan progress to the user (block 26).
iii. FindBookmarkActions—Block 27
   1. If BookMarkAction=LensCover, FindDarkFrames The video is scanned for the locations of its frames that meet the set thresholds.
   2. If BookmarkAction=HighPitchedVoice,
      FindHighPitchedFrames
   The video is scanned for the locations of its frames that meet the set thresholds.
iv. FindVideoChunks
   The list of dark frame locations is converted into a set of timespans. Here is where we verify that the dark frames occurred within a certain threshold of each other. We also use the highlight duration value to determine how long the timespan should be. There is also a setting to ignore highlights that occur in the first ten seconds of video because we found that users sometimes accidentally triggered the bookmark when they pressed “record” on the camera. If bookmark actions are found, as in the decision block 28, the sequence proceeds. Note that although the system preferably is set up so that the user places bookmarks immediately after an event of interest, it can be set up for placing the bookmarks immediately before an anticipated event of interest. The timespans to be spliced (copied) are selected accordingly.
   a. SpliceVideo—Block 30
      Use FFmpeg to create a separate highlight video based on the timespan of the video chunk. This continues in a loop for each video chunk until no more bookmark actions are found, as shown in the flow chart. In a modified version of the process and system, the user is able to manually adjust each highlight duration after the bookmarks are found but before the new highlights are created. Note also that the creation of a separate highlight video, or copying to a highlight file, is intended to include copying to a timeline in a video editing program as part of a larger movie.

9. DisplayHighlightVideos (Not shown on flow chart)

The software opens up a Windows Explorer window with the user's new highlight videos selected. The software UI also displays how many highlight videos were found.

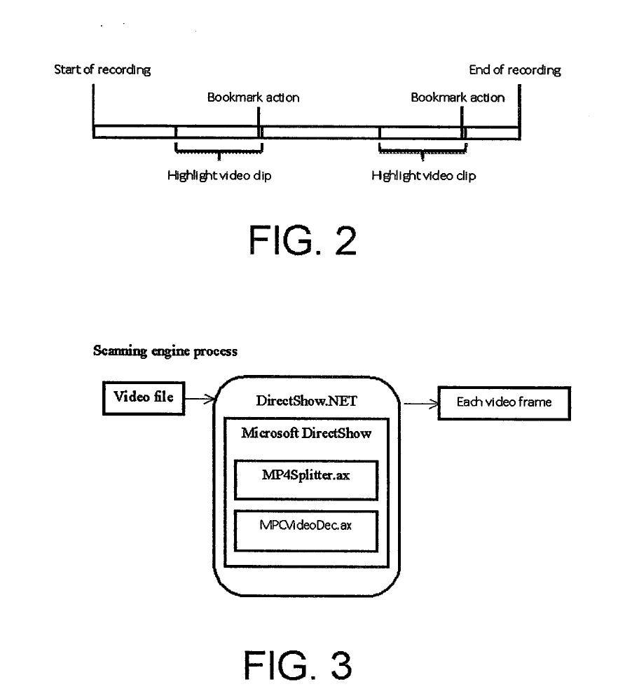

FIG. 2 is a schematic representation of the user's video, the located bookmarks, and the spliced highlight video clips, in the preferred setup of the system where the bookmarks are made immediately following an event of interest (as opposed to immediately preceding an anticipated event of interest). Note that the bookmark action slightly precedes the end of the video clip so that the user can see the complete bookmark action.

FIG. 3 indicates data flow of the video file being scanned. The drawing illustrates how a video file is processed by Microsoft DirectShow within the scanning engine process. The procedure returns a list of timespans of the user's highlights.

The DirectShow.net component is a wrapper for the Microsoft DirectShow component. To read each frame of the video file, Microsoft DirectShow enlists the help of two DirectShow filters, as noted above, MP4Splitter.ax and MPCVideoDec.ax. As explained above, a different scanning system can be used if desired.

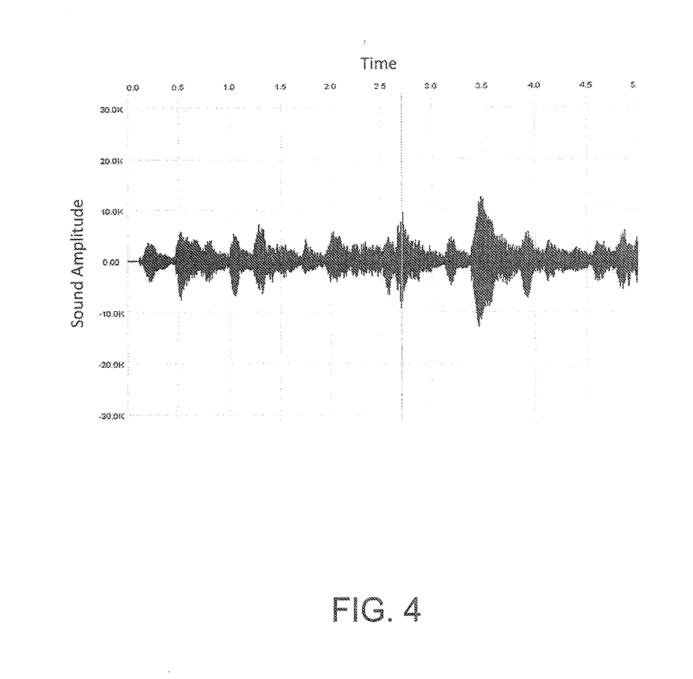

FIG. 4 is a graph to illustrate detecting bookmarks in an audio sequence of a video recording. This is amplitude versus time and indicates a bookmark at time 3.5. Bookmark detection can be based on frequency, as noted above, in the case of a high-pitched shout as a bookmarking signal. It could be based on a combination of amplitude and frequency, if desired.

The above described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

I claim:

1. A method for capturing video clips of interest from a video camera producing a video stream during a user's activity, the video camera being mounted on or held by the user or a vehicle or other implement operated by the user, comprising:
initiating a recording sequence on the video camera, to record the activity,
immediately preceding or following an event the user believes may be of interest during the conduct of the activity, making a bookmark or flag in the video by the user's either making an audible or visual software-recognizable signal recorded in the video sequence, or covering a lens of the camera for a plurality of video frames in the sequence,
switching off the video camera to end the recording sequence,
using at least one programmed computer, searching for and locating any bookmarks in the video stream of the user activity, and copying to a highlight file a video highlight clip comprising a preselected duration of time in the video stream as indicated by each bookmark, and
the user's reviewing the bookmarked video highlight clips in one or more highlight files, for further processing as desired.

2. The method of claim 1, wherein the camera is mounted on the user.

3. The method of claim 1, wherein the camera is aimed at the user.

4. The method of claim 1, wherein the user makes the bookmark by covering the camera lens and the user additionally calls out verbally an identifier for the highlight clip.

5. The method of claim 1, wherein said programmed computer is in the video camera.

6. The method of claim 1, wherein the camera records video on a memory card, and wherein one said programmed computer is in the video camera and records bookmark locations on the SD card.

7. The method of claim 6, wherein another said programmed computer is separate from the video camera, is connected to the video camera after the activity, receives from the camera locations of bookmarks, and copies to the highlight file one or more said video highlight clips.

8. The method of claim 6, wherein said one programmed computer copies to the highlight file on the SD card said video highlight clips.

9. The method of claim 1, wherein the preselected duration of time is about thirty seconds.

10. The method of claim 1, wherein the preselected duration of time is selected by the user.

11. The method of claim 1, further including using a smartphone or tablet computer connected to the video camera as a said programmed computer to determine what bookmarks have been made, and downloading highlight clips identified by the bookmarks into the smartphone or tablet computer.

12. The method of claim 1, further including using a smartphone or tablet computer connected to the video camera as one said programmed computer to determine what bookmarks have been made and to produce on the smartphone or tablet computer a list of bookmark locations.

13. A method for capturing video clips of interest from a video camera producing a video stream during an activity without manual inputs to the video camera, comprising:
initiating a recording sequence on the video camera, to record the activity,
immediately preceding or following an event the user believes may be of interest during the conduct of the activity, making a bookmark or flag in the video by the user's either (1) making an audible or visual software-recognizable signal recorded in the video sequence, or (2) covering a lens of the camera for a plurality of video frames in the sequence,
switching off the video camera to end the recording sequence,
using at least one programmed computer, searching for and locating any bookmarks in the video stream of the activity, and copying to a highlight file a video highlight clip comprising a preselected duration of time in the video stream as indicated by each bookmark, and
the user's reviewing the bookmarked video highlight clips in one or more highlight files, for further processing as desired.

14. The method of claim 13, wherein the camera is mounted on the user.

15. The method of claim 14, wherein the camera is aimed at the user.

16. The method of claim 13, wherein the camera records video on a memory card, and wherein one said programmed computer is in the video camera and records bookmark locations on the SD card.

17. The method of claim 13, wherein another said programmed computer is separate from the video camera, is connected to the video camera after the activity, receives from the camera locations of bookmarks, and copies to the highlight file one or more said video highlight clips.

18. The method of claim 13, wherein the step of making a bookmark comprises making one of a plurality of different software-recognizable hand gestures, each of the plurality signifying a different command for producing a highlight clip.

19. The method of claim 13, wherein the step of making a bookmark comprises moving the camera in a way that is software-recognizable as a bookmark action.
